(19) United States
(12) Patent Application Publication
(10) Pub. No.: US 2016/0005117 A1
(43) Pub. Date: Jan. 7, 2016

(54) ALLOCATION BASED ON ORDER QUALITY

(71) Applicant: Chicago Mercantile Exchange Inc., Chicago, IL (US)

(72) Inventors: John Scheerer, Chicago, IL (US); Michael J. Kaspar, Chicago, IL (US); Akira Yamaguchi, Chicago, IL (US)

(21) Appl. No.: 14/323,695

(22) Filed: Jul. 3, 2014

(51) Int. Cl. G06Q 40/04

(52) U.S. Cl. CPC G06Q 40/04

(57) ABSTRACT

An incoming order is matched or allocated to trade with a plurality of resting orders. Order book data indicative of the resting orders is obtained. For each resting order, a set of order quality factor scores is determined based on the order book data. The order quality factor scores include any combination of two or more of a first factor score indicative of order quantity, a second factor score indicative of order book position, and a third factor score indicative of order duration without modification. A ranking of the plurality of resting orders is determined based on the set of order quality factor scores determined for each order of the plurality of resting orders. A volume of the incoming order is allocated across a subset of orders of the plurality of resting orders based on the ranking in partial satisfaction of the incoming order.

### BACKGROUND

A financial instrument trading system, such as a futures exchange, referred to herein also as an “Exchange”, such as the Chicago Mercantile Exchange Inc. (CME), provides a contract market where financial products/instruments, for example futures and options on futures, are traded. The term “futures” is used to designate all contracts for the purchase or sale of financial instruments or physical commodities for future delivery or cash settlement on a commodity futures exchange. A futures contract is a legally binding agreement to buy or sell a commodity at a specified price at a predetermined future time, referred to as the expiration date or expiration month. An option is the right, but not the obligation, to sell or buy the underlying instrument (in this case, a futures contract) at a specified price within a specified time. The commodity to be delivered in fulfillment of the contract, or alternatively, the commodity, or other instrument/asset, for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract price.

Typically, the Exchange provides for a centralized “clearing house” through which all trades made must be confirmed, matched, and settled each day until offset or delivered. The clearing house is an adjunct to the Exchange, and may be an operating division thereof, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

Current financial instrument trading systems allow traders to submit orders and receive confirmations, market data, and other information electronically via a network. These “electronic” marketplaces have largely supplanted the pit based trading systems whereby the traders, or their representatives, all physically stand in a designated location, i.e. a trading pit, and trade with each other via oral and hand based communication. In contrast to the pit based trading system where like-minded buyers and sellers can readily find each other to trade, electronic marketplaces must electronically “match” the orders placed by buyers and sellers on behalf thereof. Electronic trading systems may offer a more efficient and transparent system of trading. For example, in pit trading, subjective elements and limits on human interaction may unduly influence the process by which buyers and sellers come together to trade or otherwise limit the trading opportunities, limiting market liquidity. In contrast, an electronic exchange may be more objective when matching up a buyer and seller, relying solely on objective factors such as price and time of order placement, etc. As such, electronic trading systems may achieve more fair and equitable matching among traders as well as identify more opportunities to trade, thereby improving market liquidity.

### BRIEF DESCRIPTION OF THE DRAWINGS

FIG. 1 depicts an illustrative computer network system that may be used to implement aspects of the disclosed embodiments.

FIG. 2 is a block diagram of an exemplary implementation of the system of FIG. 1 for allocation based on order quality in accordance with one embodiment.

FIG. 3 depicts a flow chart showing operation of the systems of FIGS. 1 and 2.

FIG. 4 shows an illustrative embodiment of a general computer system for use with the systems of FIGS. 1 and 2.

### DETAILED DESCRIPTION

The disclosed embodiments relate to systems and methods which match or otherwise allocate an incoming order to trade with a “resting,” i.e., previously received but not yet matched, orders. The disclosed embodiments relate to a match engine that prioritizes the resting orders based on the quality of the resting orders. A portion of the incoming order is allocated in accordance with the prioritization. The quality of the resting orders may be assessed by quantifying an extent to which the resting order improves the market. The market may be improved by the resting orders in various ways, including, for instance, by improving liquidity or supporting higher volume activity.

The quality of the resting orders may be provided as a ranking or quality score. The quality score may be computed based on a number of different qualitative metrics, such as order size, order book position, order duration, or other measured and/or derived metrics or combinations thereof. A predetermined portion (e.g., 20%) of the incoming order may then be allocated to those orders deemed to be high quality orders based on the quality score. Orders may be considered of high quality by a relative quality ranking (e.g., the three orders with the highest scores), an absolute ranking, and/or by other quality score comparisons (e.g., orders having a quality score greater than a threshold score).

In some cases, the ranking incorporates the quality of the quoting history of a market participant. To that end, the quality of the orders placed by market participants (e.g., the ranking and/or quality score) is tracked or otherwise stored over time. A market participant that has a history of high quality orders may thus be awarded with a greater percentage of an incoming order. The quality-based allocation of the disclosed embodiments may be available to a predetermined number of resting orders and/or to those resting orders having a quality score above a threshold.

The disclosed embodiments may provide and promote more widespread participation in markets. By dedicating a certain percentage of an incoming order to high quality orders, the disclosed embodiments may encourage market participants to place orders of higher quality. The disclosed embodiments may incentivize market making behavior over aggressor behavior. For example, the disclosed embodiments may incentivize the submission of orders that reflect, or at least better reflect, the true intent of the market participant. The higher quality orders may strengthen markets, especially those markets that may otherwise be illiquid. While the disclosed embodiments may be useful in connection with addressing illiquid markets, the disclosed embodiments may be useful in connection with a variety of different markets and financial products.

The quality-based allocation of the disclosed embodiments may be implemented to provide an initial allocation. The disclosed embodiments may be used in connection with one or more additional matching procedures. The additional matching procedure(s) may be implemented after the quality-based allocation to allocate the remaining portion of the incoming order. While described below as an initial allocation, the disclosed embodiments may be used at various phases or stages of order allocation. A variety of different matching algorithms or procedures may be used in conjunction with the quality-based allocation of the disclosed embodiments. Examples of other allocation techniques are time-stamp-based procedures (first-in, first-out, or FIFO), pro rata procedures, and combinations thereof. The disclosed embodiments may also be integrated with these and other procedures to skew or otherwise modify the order allocation otherwise established thereby. In these and other ways, the benefit of speed may not be eliminated altogether by the disclosed embodiments. Speedy order submission may be rewarded when it improves market liquidity and/or other health metrics.

The disclosed embodiments may lead to more productive exchange computer systems. By incentivizing higher quality orders, the overall number of orders for a given amount of trading volume may decrease. The exchange computer system may thus process the same trading volume more efficiently. For example, the reduced number of orders may decrease the processing load of one or more processors of the exchange computer system. Alternatively or additionally, the reduced number of orders may lead to decreased memory requirements. For example, order book and trade database modules may not need to store as much data. A lower number of orders (for a given trading volume) may also lead to reduced network traffic loads for the exchange computer system. Additional or alternative efficiencies may be realized via the disclosed embodiments.

While the disclosed embodiments may be discussed in relation to futures and/or options on futures trading, it will be appreciated that they may be applicable to any equity, options or futures trading system, e.g., exchange, Electronic Communication Network (“ECN”), Alternative Trading System (“ATS”), or Swap Execution Facility (“SEF”), or market now available or later developed, e.g. cash, Futures, etc., as well as any instrument traded thereon. It will be appreciated that a trading environment, such as a futures exchange as described herein, implements one or more economic markets where rights and obligations may be traded. As such, a trading environment may be characterized by a need to maintain market integrity, transparency, predictability, fair/equitable access and participant expectations with respect thereto. For example, an exchange must respond to inputs, such as trader orders, cancellation, etc., in a manner as expected by the market participants, such as based on market data, e.g. prices, available counter-orders, etc., to provide an expected level of certainty that transactions will occur in a consistent and predictable manner and without unknown or unascertainable risks. In addition, it will be appreciated that electronic trading systems further impose additional expectations and demands by market participants as to transaction processing speed, latency, capacity and response time, while creating additional complexities relating thereto. Accordingly, as will be described, the disclosed embodiments may further include functionality to ensure that the expectations of market participants are met, e.g. that transactional integrity and predictable system responses are maintained.

As was discussed above, electronic trading systems ideally attempt to offer an objective, efficient, fair and balanced market where market prices reflect a true consensus of the value of products traded among the market participants, where the intentional or unintentional influence of human interaction is minimized, if not eliminated, and where unfair or inequitable advantages with respect to information access are minimized if not eliminated.

Further, as discussed above, an exchange provides one or more markets for the purchase and sale of various types of products including financial instruments such as stocks, bonds, futures contracts, options, currency, cash, and other similar instruments. Agricultural products and commodities are also examples of products traded on such exchanges. A futures contract is a product that is a contract for the future delivery of another financial instrument such as a quantity of grains, metals, oils, bonds, currency, or cash. Generally, each exchange establishes a specification for each market provided thereby that defines at least the product traded in the market, minimum quantities that must be traded, and minimum changes in price (e.g., tick size). For some types of products (e.g., futures or options), the specification further defines a quantity of the underlying product represented by one unit (or lot) of the product, and delivery and expiration dates. As will be described, the Exchange may further define the matching procedure, or rules, by which incoming orders will be matched or allocated to resting orders.

Some products on an exchange are traded in an open outcry environment where the exchange provides a location for buyers and sellers to meet and negotiate a price for a quantity of a product. Other products are traded on an electronic trading platform (e.g., an electronic exchange), also referred to herein as a trading platform, trading host or Exchange Computer System, where market participants, e.g. traders, use software to send orders to the trading platform. The order identifies the product, the quantity of the product the trader wishes to trade, a price at which the trader wishes to trade the product, and a direction of the order (i.e., whether the order is a bid, i.e., an offer to buy, or an ask, i.e., an offer to sell).

The Exchange Computer System, as will be described below, monitors incoming orders received thereby and attempts to identify, i.e., match or allocate, as will be described in more detail below, one or more previously received, but not yet matched, orders, i.e., limit orders to buy or sell a given quantity at a given price, referred to as “resting” orders, stored in an order book database, where each identified order is contra to the incoming order and has a favorable price relative to the incoming order. An incoming order may be an “aggressor” order, i.e., a market order to sell a given quantity at whatever may be the resting bid order price(s) or a market order to buy a given quantity at whatever may be the resting ask order price(s). In particular, if the incoming order is a bid, i.e., an offer to buy, then the identified order(s) will be an ask, i.e., an offer to sell, at a price that is identical to or lower than the bid price. Similarly, if the incoming order is an ask, i.e., an offer to sell, the identified order(s) will be a bid, i.e., an order to buy, at a price that is identical to or higher than the offer price.

Upon identification (matching) of a contra order(s), a minimum of the quantities associated with the identified order and the incoming order is matched and that quantity of each of the identified and incoming orders become two halves of a matched trade that is sent to a clearinghouse. The Exchange Computer System considers each identified order in this manner until either all of the identified orders have been considered or all of the quantity associated with the incoming order has been exhausted/matched, i.e. the order has been filled. If any quantity of the incoming order remains, an entry may be created in the order book database and information regarding the incoming order is recorded therein, i.e., a resting order is placed on the order book for the remaining quantity to await a subsequent incoming order counter thereto.

Traders access the markets on a trading platform using trading software that receives and displays at least a portion of the order book for a market, i.e. at least a portion of the currently resting orders. The trading software enables a trader to provide parameters for an order for the product traded in the market, and transmits the order to the Exchange Computer System. The trading software typically includes a graphical user interface to display at least a price and quantity of some of the entries in the order book associated with the market. The number of entries of the order book displayed is generally preconfigured by the trading software, limited by the Exchange Computer System, or customized by the user. Some graphical user interfaces display order books of multiple markets of one or more trading platforms. The trader may be an individual who trades on his/her behalf, a broker trading on behalf of another person or entity, a group, or an entity. Furthermore, the trader may be a system that automatically generates and submits orders.

If the Exchange Computer System identifies that an incoming market order may be filled by a combination of multiple resting orders, e.g., the resting order(s) at the best price only partially fills the incoming order, the Exchange Computer System may allocate the remaining quantity of the incoming order, i.e., that which was not filled by the resting order(s) at the best price, among such identified orders in accordance with prioritization and allocation rules/algorithms, referred to as “matching algorithms” or “matching procedures,” as, for example, may be defined in the specification of the particular financial product or defined by the Exchange for multiple financial products. Similarly, if the Exchange Computer System identifies multiple orders contra to the incoming limit order and that have an identical price which is favorable to the price of the incoming order, i.e., the price is equal to or better, e.g., lower if the incoming order is a buy or higher if the incoming order is a sell, than the price of the incoming order, the Exchange Computer System may allocate the quantity of the incoming order among such identified orders in accordance with the matching algorithms as, for example, may be defined in the specification of the particular financial product or defined by the Exchange for multiple financial products.

As was noted above, an Exchange responds to inputs, such as trader orders, cancellation, etc., in a manner as expected by the market participants, such as based on market data, e.g., prices, available counter-orders, etc., to provide an expected level of certainty that transactions will occur in a consistent and predictable manner and without unknown or unascertainable risks. Accordingly, the method by which incoming orders are matched with resting orders may be defined so that traders know what the expected result will be when they place an order or have resting orders and an incoming order is received. Typically, the Exchange defines the matching algorithm to be used for a particular financial product, with or without input from the market participants. Once defined for a particular product, the matching algorithm is typically not altered, except in limited circumstances, such as to correct errors or improve operation, so as not to disrupt trader expectations. It will be appreciated that different products offered by a particular Exchange may use different matching algorithms.

For example, a first-in/first-out (FIFO) matching algorithm, also referred to as a “Price Time” algorithm, considers each identified order sequentially in accordance with when the identified order was received. A FIFO or Price Time algorithm considers the timestamp of each order in the order book. The quantity of the incoming order is matched to the quantity of the identified order received earliest, then quantities of the next earliest, and so on until the quantity of the incoming order is exhausted.

Some product specifications define the use of a pro-rata matching algorithm, where a quantity of an incoming order is allocated to each of a plurality of identified orders proportionally. Some Exchange Computer Systems provide a priority to certain standing orders in particular markets. An example of such an order is the first order that improves a price (i.e., improves the market) for the product during a trading session. To be given priority, the trading platform may require that the quantity associated with the order is at least a minimum quantity. Further, some Exchange Computer Systems cap the quantity of an incoming order that is allocated to a standing order on the basis of a priority for certain markets. In addition, some Exchange Computer Systems may give a preference to orders submitted by a trader who is designated as a market maker for the product. Other Exchange Computer Systems may use other criteria to determine whether orders submitted by a particular trader are given a preference. Typically, when the Exchange Computer System allocates a quantity of an incoming order to a plurality of identified orders at the same price, the trading host allocates a quantity of the incoming order to any orders that have been given priority. The Exchange Computer System thereafter allocates any remaining quantity of the incoming order to orders submitted by traders designated to have a preference, and then allocates any still remaining quantity of the incoming order using the FIFO or pro-rata algorithms. Pro-rata algorithms used in some markets may require that an allocation provided to a particular order in accordance with the pro-rata algorithm meet at least a minimum allocation quantity. Any orders that do not meet or exceed the minimum allocation quantity are allocated on a FIFO basis after the pro-rata allocation (if any quantity of the incoming order remains). More information regarding order allocation may be found in U.S. Pat. No. 7,853,499, the entire disclosure of which is incorporated by reference.

Other examples of matching procedures that may be used for allocation of orders of a particular financial product include:

Price Explicit Time

Order Level Pro Rata

Order Level Priority Pro Rata

Preference Price Explicit Time

Preference Order Level Pro Rata

Preference Order Level Priority Pro Rata

Threshold Pro-Rata

Priority Threshold Pro-Rata

Preference Threshold Pro-Rata

Priority Preference Threshold Pro-Rata

Split Price-Time Pro-Rata

Any one or more of the above-listed matching procedures may be used in conjunction with, or otherwise integrated with, the quality-based matching procedures of the disclosed embodiments.

For example, the Price Explicit Time trading policy is based on the basic Price Time trading policy with Explicit Orders having priority over Implied Orders at the same price level. The order of traded volume allocation at a single price level may therefore be as follows:
Explicit order with oldest timestamp first. Followed by
Any remaining explicit orders in timestamp sequence (First In, First Out—FIFO) next. Followed by
Implied order with oldest timestamp next. Followed by
Any remaining implied orders in timestamp sequence (FIFO).

In Order Level Pro Rata, also referred to as Price Pro Rata, priority is given to orders at the best price (highest for a bid, lowest for an offer). If there are several orders at this best price, equal priority is given to every order at this price and incoming business is divided among these orders in proportion to their order size. The Pro Rata sequence of events is:
1. Extract all potential matching orders at best price from the order book into a list.
2. Sort the list by order size, largest order size first. If equal order sizes, oldest timestamp first. This is the matching list.
3. Find the ‘Matching order size’, which is the total size of all the orders in the matching list.
4. Find the ‘tradable volume’, which is the smallest of the matching volume and the volume left to trade on the incoming order.
5. Allocate volume to each order in the matching list in turn, starting at the beginning of the list. If all the tradable volume gets used up, orders near the end of the list may not get allocation.
6. The amount of volume to allocate to each order is given by the formula:

(Order volume/Matching volume)*Tradable volume
The result is rounded down (for example, 21.99999999 becomes 21) unless the result is less than 1, when it becomes 1.
7. If tradable volume remains when the last order in the list had been allocated to, return to step 3.
   Note: The matching list is not re-sorted, even though the volume has changed. The order which originally had the largest volume is still at the beginning of the list.
8. If there is still volume left to trade on the incoming order, repeat the entire algorithm at the next price level.

Order Level Priority Pro Rata, also referred to as Threshold Pro Rata, is similar to the Price (or ‘Vanilla’) Pro Rata algorithm but has a volume threshold defined. Any pro rata allocation below the threshold will be rounded down to 0. The initial pass of volume allocation is carried out in using pro rata; the second pass of volume allocation is carried out using Price Explicit Time. The Threshold Pro Rata sequence of events is:
1. Extract all potential matching orders at best price from the order book into a list.
2. Sort the list by explicit time priority, oldest timestamp first. This is the matching list.
3. Find the ‘Matching volume’, which is the total volume of all the orders in the matching list.
4. Find the ‘tradable volume’, which is the smallest of the matching volume and the volume left to trade on the incoming order.
5. Allocate volume to each order in the matching list in turn, starting at the beginning of the list.
6. The amount of volume to allocate to each order is given by the formula:

(Order volume/Matching volume)*Tradable volume
The result is rounded down to the nearest lot (for example, 21.99999999 becomes 21) unless the result is less than the defined threshold in which case it is rounded down to 0.
7. If tradable volume remains when the last order in the list had been allocated to, the remaining volume is allocated in time priority to the matching list.
8. If there is still volume left to trade on the incoming order, repeat the entire algorithm at the next price level.

In the Split Price Time Pro-Rata algorithms, a Price Time Percentage parameter is defined. This percentage of the matching volume at each price is allocated by the Price Explicit Time algorithm and the remainder is allocated by the Threshold Pro-Rata algorithm. There are four variants of this algorithm, with and without Priority and/or Preference. The Price Time Percentage parameter is an integer between 1 and 99. (A percentage of zero would be equivalent to using the respective existing Threshold Pro-Rata algorithm, and a percentage of 100 would be equivalent to using the respective existing Price Time algorithm). The Price Time Volume will be the residual incoming volume, after any priority and/or Preference allocation has been made, multiplied by the Price Time Percentage. Fractional parts will be rounded up, so the Price Time Volume will always be at least 1 lot and may be the entire incoming volume. The Price Time Volume is allocated to resting orders in strict time priority. Any remaining incoming volume after the Price Time Volume has been allocated will be allocated according to the respective Threshold Pro-Rata algorithm. The sequence of allocation, at each price level, is therefore:
1. Priority order, if applicable
2. Preference allocation, if applicable
3. Price Time allocation of the configured percentage of incoming volume
4. Threshold Pro-Rata allocation of any remaining incoming volume
5. Final allocation of any leftover lots in time sequence.
Any resting order may receive multiple allocations from the various stages of the algorithm.

The disclosed embodiments may use any of the above-identified matching algorithms or procedures as an auxiliary, secondary, or other matching procedure. It will be appreciated that there may be other allocation algorithms, including combinations of algorithms, now available or later developed, which may be utilized in conjunction with the disclosed embodiments, and all such algorithms are contemplated herein.

The matching algorithm may influence the behavior of the market or individual traders. For example, some allocation algorithms may encourage traders to submit more orders, where each order is relatively small. Other matching algorithms encourage traders to submit larger orders. Other matching algorithms may encourage a trader to use an electronic trading system that can monitor market activity and submit and retract orders on behalf of the trader very quickly and without intervention.

The disclosed embodiments may be useful in encouraging traders to participate in the market via higher quality orders. Higher quality orders may be considered those that provide a market with liquidity and higher volume activity. To encourage higher quality orders, the disclosed embodiments may provide order allocations that favor truly larger orders (as opposed to orders having a size merely to improve pro rata allocation), better priced orders, order duration, and orders from traders having a history of making higher quality orders. The disclosed embodiments may thus not reward speed as much as other procedures.

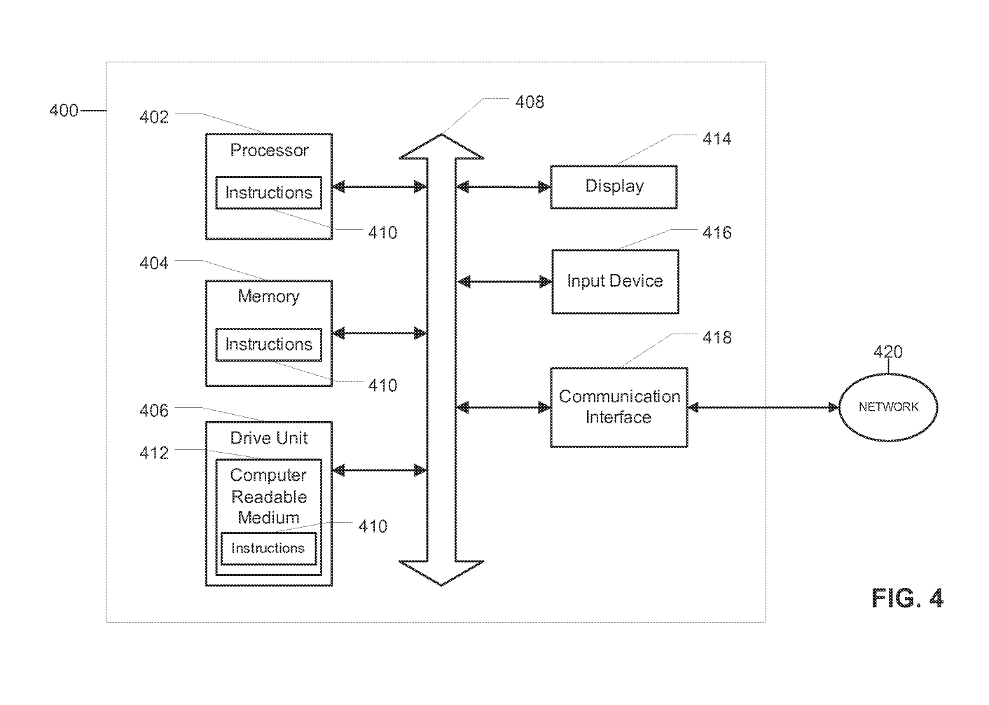

The disclosed embodiments may be implemented with computer devices and computer networks, such as those described with respect FIG. 4, that allow users, e.g. market participants or traders, to exchange trading information. It will be appreciated that the plurality of entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the exchange.

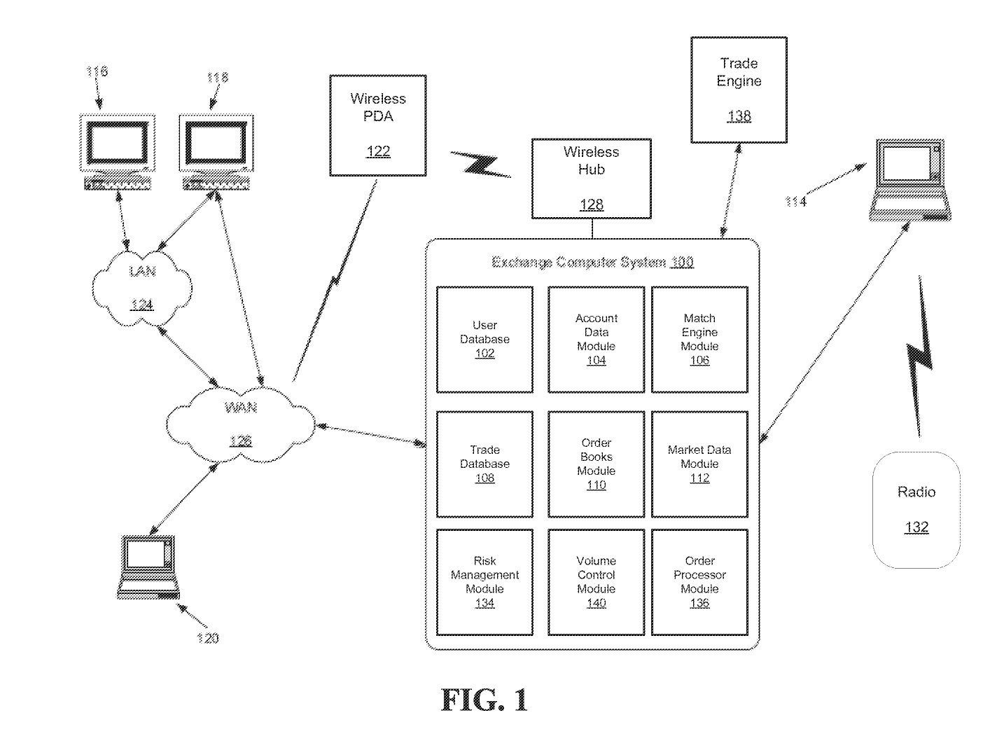

An exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as will be described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herein unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

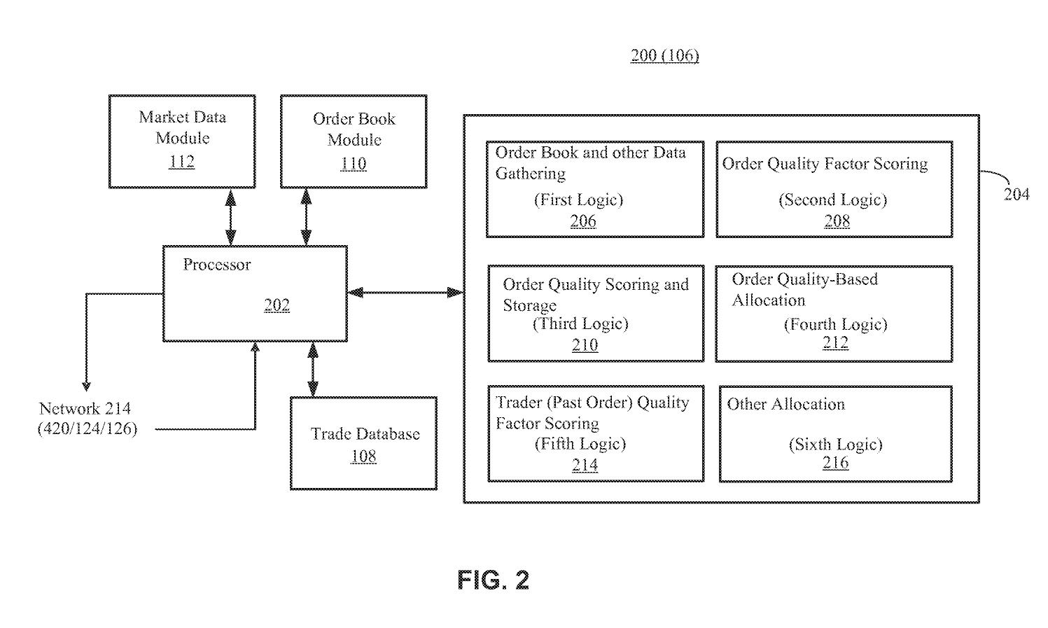

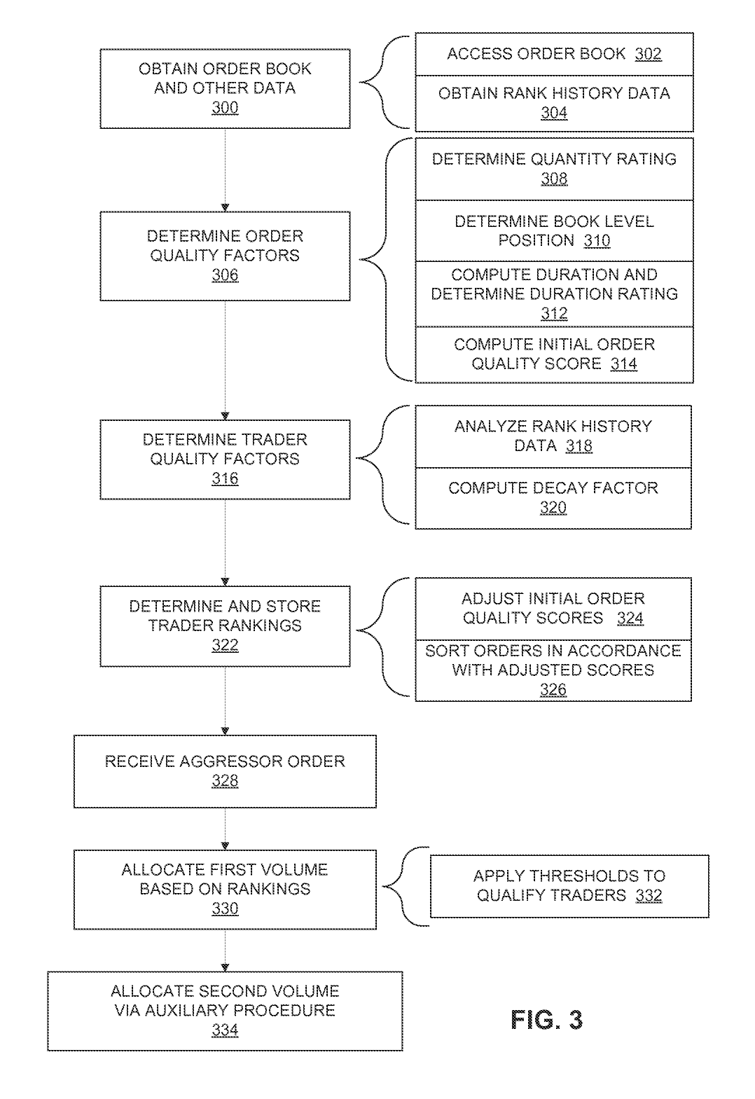

The exchange computer system 100 may be implemented with one or more mainframe, desktop or other computers, such as the computer 400 described below with respect to FIG. 4. A user database 102 may be provided which includes information identifying traders and other users of exchange computer system 100, such as account numbers or identifiers, user names and passwords. An account data module 104 may be provided which may process account information that may be used during trades. A match engine module 106 may be included to match bid and offer prices and may be implemented with software that executes algorithms for matching bids and offers as will be described in more detail below in connection with FIGS. 2 and 3. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by the order book module 110 and/or match engine module 106. A volume control module 140 may be included to, among other things, control the rate of acceptance of mass quote messages in accordance with one or more aspects of the disclosed embodiments. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122 which depict different exemplary methods or media by which a computer device may be coupled with the exchange computer system 100 or by which a user may communicate, e.g. send and receive, trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may comprise a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based computer device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

As was described above, the users of the exchange computer system 100 may include one or more market makers that may maintain a market by providing constant bid and offer prices for a derivative or security to the exchange computer system 100, such as via one of the exemplary computer devices depicted. The exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a computer-readable storage medium (as opposed to computer-readable communication media involving propagating signals) or a non-transitory computer-readable storage medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may include other components not shown and be connected by numerous alternative topologies.

FIG. 2 is a block diagram to depict the match engine module 106 according to one embodiment, which, in an exemplary implementation, is implemented as part of the exchange computer system 100 described above. As used herein, an exchange 100 includes a place or system that receives and/or executes orders.

In the example of FIG. 2, a system 200 is provided for matching, or otherwise allocating, an aggressor or other incoming order for a quantity of a financial product with one or more of a set of previously received unmatched (i.e., resting) orders for the financial product that are counter to the aggressor order, e.g., at the same or better price than the incoming order. In one embodiment, the financial product is a derivative product such as a futures contract or option contract on a futures contract. Alternatively, or in addition thereto, the financial product may include a cash-market instrument, such as a swap. The system 200 includes a processor 202 and a memory 204 coupled therewith. The processor 202 and the memory 204 may be implemented as a processor 402 and a memory 404 as described below with respect to FIG. 4.

During operation, the processor 202 may access the order book module 110 to receive or otherwise obtain data indicative of the resting orders and the incoming order. In the embodiment of FIG. 2, the system 200 includes first logic 206 stored in the memory 204 and executable by the processor 202 to cause the processor 202 to obtain order book data indicative of the plurality of resting orders. The data may be accessed at the outset, e.g., before implementation of the matching procedures, and/or during such implementation as needed. In some cases, the data may be temporarily stored in the memory 404 and/or another memory for use during operation. Temporary or other data generated during operation may also be stored in the memory 404 and/or another memory.

The first logic 206 may also cause the processor 202 to access or otherwise obtain other data. For example, data indicative of the order history of the traders behind the resting orders may be obtained. As described below, the quality of past orders may be tracked for later use in the allocation procedure. For example, data indicative of previous order quality rankings and/or order quality scores may be stored for later use in in determining future order quality scores or rankings in accordance with the allocation procedure. In some cases, a weighting factor or multiplier may be determined from such historical quality data. The historical quality data may be obtained from a variety of sources. In some cases, the historical data is stored in the trade database 108, the market data module 112, and/or other component or unit of the system 100 (FIG. 1).

The system 200 further includes second logic 208 stored in the memory 204 and executable by the processor 202 to cause the processor 202 to determine, for each order of the plurality of resting orders, a set of order quality factor ratings or other scores based on the order book data. The order quality factor scores may include a first factor score indicative of order quantity, a second factor score indicative of order book position, and a third factor score indicative of order duration. Examples of each order quality factor are provided below. The second logic 208 may cause the processor 202 to score any number and/or combination of two or more of the above-referenced order quality factors. For example, the first and second factor scores may be determined and used in some cases, while the second and third factor scores may be determined and used in other cases. In still other cases, all three factor scores are determined and used.

The scores may be determined via the second logic 208 at various points in time. For example, the scores may be determined upon receipt of an incoming order and/or be triggered by another event. For example, one or more of the scores may be determined upon a modification of one or more resting orders. Updating the scores may be useful as the underlying order book data changes over time as described below. The scores may alternatively or additionally be determined and/or updated on a periodic basis (e.g., hourly, daily, etc.).

One or more of the scores may be provided along a scale or other distribution. The scale may be an integer scale (e.g., 1-10) or a floating point scale (e.g., 0.0-30.0). Different scales or ranges may be used for different scores. The scores are not limited to continuous or linear scales or ranges. In other cases, the scores are selected from a non-linear, discontinuous, and/or non-consecutive set of numbers. For example, one or more of the scores may proceed logarithmically (e.g., 1, 10, 100, etc.). The second logic 208 may use these and other differences in scoring arrangements to vary the relative weight of the order quality factors.

A higher order quantity score may be indicative of an improvement in the order quality factor. For example, a higher score may be indicative of increasing order size, longer resting duration, or better book position. In other embodiments, the scores may decrease with improvements in quality.

The order quantity score or rating is indicative of the size of the order. For example, a rating of 10 may be representative of a larger or largest order size, while a rating of 1 is representative of a smaller or smallest order size. In some cases, order quantities may be bucketed or grouped in accordance with respective size ranges. For example, orders of 1-10 lots may be assigned a score of 1, and orders of 11-20 lots may be assigned a score of 2, and so on, as desired. The ranges may vary by product, insofar as some products may tend to have higher lot orders than other products. In other cases, the order size score may be a normalized representation of the size of the order. For example, the order size score may be normalized to 20-lot orders, such that a 67-lot order may be awarded a score of 3.35 (i.e., 67 divided by 20). In such cases, the second logic 208 may be configured to establish a maximum factor score. For example, all orders at 200 lots or higher may receive a maximum score of 10 (i.e., 200 divided by 20).

The order book position score or rating is indicative of the order's position in the order book. The order book arranges the orders by price. On the bid side of the order book, the order with the highest bid price has the first book position, the order with the next highest bid price has the second book position, and so on. On the ask side of the order book, the order with the lowest ask price has the first book position, the order with the next lowest ask price has the second book position, and so on. In one example, a rating of 10 may be awarded for the first book position, a rating of 9 may be awarded for the second book position, and so on through a total of 10 levels of book position. In other cases, order book position scores may be awarded in accordance with groups of order book positions. For example, orders in the first book position may be awarded a score of 20, while orders in the second through fourth positions may be awarded a score of 15, orders in the fifth through eighth positions may be awarded a score of 10, and orders in the ninth, tenth, and lower positions may be awarded a score of 5.

The order duration score or rating is indicative of the time that the order has rested without any modifications. A duration clock provided by the second logic 208 may be reset upon a modification of the order. Modifications that result in a reset of the duration clock may include changes to the price, quantity, and/or other parameter of the order. Taking modifications into account may incentivize the submission of properly sized orders. Partial satisfaction of the resting order may also reset the clock. The second logic 208 may cause the processor 202 to obtain and use timestamp data to determine the time point of the last modification (and/or the time period between the last modification and the time at which the factor score is determined).

The order duration score may be determined through a bucketing or grouping in accordance with duration ranges. For example, orders that have rested without modification for the duration ranges identified below may be awarded scores as follows:

| Duration | | core |
|---|---|---|
| >5 | sec | 10 |
| 1-5 | sec | 9 |
| 800-999 | ms | 7 |
| 500-799 | ms | 5 |
| 300-499 | ms | 4 |
| 100-299 | ms | 2.5 |
| <100 | ms | 1 |

The ranges of the duration time periods may vary from the example above. For example, the time period for each range may differ based on the product. The scores may also vary. In some cases, the scores may be arranged in a linear, non-linear, non-integer, or non-consecutive progression. For instance, the scores may be normalized duration time values. In one example, the score may be computed relative to a one second base duration. An order resting for 4 seconds is then awarded a score of 4, while an order resting for 600 ms is awarded a score of 0.6. The second logic 208 may be configured to establish a maximum factor score. For example, with a maximum factor score of 10, all orders resting for 10 seconds or more are awarded a score of 10.

The exemplary ranges of the order quality factor scores described above are provided for ease in explanation. For instance, the factor scores need not range from 1-10. The factor scores may have ranges that differ from one another. For example, the size factor score may range from 0 to 50, while the time duration score may range from 10 to 25. In these and other ways, the relative effects of the individual scores may be customized for a particular product or market.

The system 200 further includes third logic 210 stored in the memory 204 and executable by the processor 202 to cause the processor 202 to determine a ranking of the plurality of resting orders. The ranking is based on the set of order quality factor scores determined for each resting order. In some cases, the ranking is determined by computing an order quality score for each resting order (i.e., an aggregate score). The aggregate score may be considered an initial order quality score due to further processing that occurs after the aggregation, as described below. In some cases, the aggregate order quality score may be computed by summing the individual order quality factor scores. In a three-factor case with scores of 9 (quantity factor score), 5 (book level factor score), and 4 (duration factor score), the initial order quality score is 18. The orders may then be ranked from highest aggregate score to lowest aggregate score. In other embodiments, the ranking may proceed from lowest aggregate score to highest aggregate score.

The individual order quality factor scores may be combined in other ways to compute the initial order quality score. For example, the size factor and book level factor scores may be averaged before adding the duration factor score. In the example above, the initial order quality score would be 11 (7+4). A variety of different techniques may be used to provide a matching outcome that is both fair and likely to provide the proper incentives to traders.

The third logic 210 may also be executable by the processor 202 to cause the processor 202 to store ranking data for each resting order in association with a trader responsible for the order. The ranking data may include the relative rank (e.g., second in the ranking) and/or the value of the aggregate score (e.g., 37.5). Such ranking data may be stored as historical data for the trader responsible for the order. The historical data may be taken into account later to adjust the score, as described below.

The ranking data may be stored at various times after the determination of the aggregate score. For example, the raw ranking data may be stored before any subsequent adjustments. Alternatively or additionally, the raw ranking data may be stored in conjunction with processed ranking data that reflects the subsequent adjustments.

The system 200 further includes fourth logic 212 stored in the memory 204 and executable by the processor 202 to cause the processor 202 to allocate a volume of the incoming order across a subset of the resting orders based on the ranking. The allocation results in partial satisfaction of the incoming order. The subset of the resting orders may qualify for the allocation based on whether the ranking is better than a threshold and/or based on whether the aggregate score is better than a threshold. For example, a portion of the incoming order may be distributed across the top six ranked resting orders. The portion to be allocated in this manner may be about 20% or 25%, but other percentages may be used.

In some cases, the fourth logic 212 is further executable by the processor 202 to cause the processor 202 to distribute the volume across the subset of orders in a manner that allocates a greater percentage of the volume to higher ranked orders of the plurality of resting orders. For example, if the portion to be distributed is 20%, then the distribution by resting order may be as follows:

| Rank Position | Awarded Percentage |
|---|---|
| 1 | 7% |
| 2 and 3 | 4.5% |
| 4-6 | 3% |

Other distribution arrangements may be used. For example, each rank position may be awarded a respective, different percentage of the incoming order. In other examples, each qualifying order is allocated an equal percentage of the incoming order.

The percentage of the incoming order to be distributed via the quality-based allocation techniques of the disclosed embodiments may be adjustable. For example, the percentage may be lowered if the total number of resting orders is too low (e.g., below a threshold). Alternatively or additionally, the fourth logic 212 may adjust the number of orders that may qualify for the quality-based allocation. For example, the fourth logic 212 may specify a maximum proportion (e.g., 50%) of the resting orders that may qualify. Thus, if only four resting orders are present, then only two of the resting orders may qualify for the quality-based allocation.

In some cases, the fourth logic 212 is further executable by the processor 202 to cause the processor 202 to apply a scoring threshold to identify the resting orders that qualify for the allocation. For example, the scoring threshold may be a fixed number. Those orders with higher (alternatively, lower) scores qualify for the allocation. While the scoring threshold will vary for different products, the scoring threshold need not be fixed for a particular product. For example, the scoring threshold may vary based on the average or median score or other parameters based on any combination of the order book and market data available at the time of matching.

In the embodiment of FIG. 2, the system 200 further includes fifth logic 214 stored in the memory 204 and executable by the processor 202 to cause the processor 202 to determine a trader quality factor score for each resting order. The trader quality factor score is based on historical data indicative of the ranking from one or more past ranking determinations for the trader associated with the respective order. The historical data may include the order quality score, the ranking achieved by the trader, and/or whether the trader qualified for the quality-based allocation. The historical data may be indicative of the extent to which the trader has been active in a particular market and/or to what extent the orders from the trader during that time period have been considered high quality orders. For example, the rank achieved by the trader in the last several rankings may be obtained to determine the trader quality factor score. Examples of trader quality factor score determinations are provided below. Once determined, the trader quality factor score may then be used to determine the quality score of the present resting order. By incorporating the trader quality factor score, traders that have been active in the particular market for longer periods of times may receive a higher order quality score.

The past order quality scores, ranks, and/or other past order activity may be used in the order quality determination. To that end, the fifth logic 214 may cause the processor 202 to obtain historical data indicative of previous orders from the trader, the quality scores determined for the previous orders, and/or the resulting rank positions. In one example, historical data may be obtained for the previous ten weekly rankings to determine how long the trader has quoted the market. A trader quality factor score may then be determined from predetermined buckets or groups of consecutive time periods of orders. For example, a score of 1.0 is awarded when orders were received for eight or more weeks, 0.8 when orders were received for four to eight weeks, 0.5 when orders were received for two to four weeks, 0.2 when orders were received for last two weeks, and 0.0 for no previous orders). The forgoing ranges and score may alternatively be applicable to how long the trader has consecutively posted orders that qualify as high quality orders, e.g., by meeting a threshold, etc.

The third logic 210 may then be further executable by the processor 202 to cause the processor 202 to determine an order quality score for each resting order based on the trader quality factor score. In some examples, the trader quality factor score may be applied as a decay factor (or other weighting factor or linear multiplier) to an initial order quality score. As described above, the third logic 210 may be executable by the processor 202 to cause the processor 202 to compute an initial order quality score for each resting order. The trader quality factor score may then be applied to the initial order quality score. Thus, in the foregoing example, with a trader quality factor score of, e.g., 0.2, and an initial order quality score of 24, the resulting order quality score is 4.8 (0.2×24). Another trader with the same initial order quality score but a trader quality factor score of 0.4 (reflecting a longer history of high quality trades), achieves an order quality score of 9.6 (0.4×24).

The initial order quality score may be adjusted based on the trader quality factor score in other ways. The trader quality factor score need not be applied as a decay factor. For example, the trader quality factor score and the initial order quality score may be summed.

The quality score to which the trader quality factor score is applied may also vary. For example, the trader quality factor score may be applied as a multiplier or other adjustment to one or more of the individual order quality factor scores rather than the aggregate quality factor score.

Other examples of decay factors or multipliers are based on the past rank positions and/or the underlying order quality scores. For example, the average or median historical rank may be computed and bucketed to determine the decay factor. For example, average historical ranks that fall in a range from 1 to 3 are entitled to a multiplier of 1.0, while average ranks that fall in a range from 3-6 are entitled to a multiplier of 0.5 and all other traders use a multiplier of 0.1. The multiplier may be applied to adjust the initial order quality score as described above.

One or more of the other order quality factor scores may be configured for use as a decay factor, weighting factor, or other multiplier. For example, the order book level score may range from 0.0 (lowest book level) to 1.0 (highest book level). The order book level score may then be applied to the size factor score as a multiplier. Other multiplier arrangements may be used.

The rankings may be determined weekly, biweekly, monthly, or at any other frequency. The historical data from the past rankings may be obtained at different intervals than those established by the frequency of the rankings.

In some embodiments, the system 200 may further include sixth logic 216 stored in the memory 204 and executable by the processor 202 to cause the processor 202 to allocate a remaining volume of the incoming order in accordance with a further matching procedure. After the quality-based allocation is implemented via the fourth logic 212, the processor 202 may implement one or more further matching procedures to allocate the remaining percentage of the incoming order (e.g., 80% of the incoming order). The further matching procedure may be configured to implement a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

The sixth logic 216 may be configured to apply allocation limits in addition to those applied by the fourth logic 212. For example, the sixth logic 212 may specify that, within the total allocation (i.e., 100% of the incoming order), no one order can fill more than a certain percentage of the incoming order. Other types of limits may alternatively or additionally be applied.

FIG. 3 depicts a flow chart showing operation of the system 200 of FIG. 2. In particular, FIG. 3 shows a computer implemented method for matching, or otherwise allocating, an incoming order for a quantity of a financial product with one or more of a plurality of resting orders that are unmatched and counter to the incoming order, e.g. at the same or better price than the first order. The financial product may vary as described above. The order of the acts or steps of the operation may vary from the example shown. For example, the incoming order may be received before or during the quality ranking determination. Additional, fewer, or alternative acts may be implemented. For example, a trader quality factor may not be determined.

The operation of the system 200 may begin with obtaining order book data indicative of the plurality of resting orders [block 300]. The order book data may be obtained by accessing the order book [block 302] or order book module 110 (FIG. 1). Past rank data or other historical order data may also be obtained in conjunction with the order book data [block 304]. The historical data may be used to assess to what extent the trader behind the order has been active in the market and/or to what extent the trader has previously provided high quality orders.

Order quality factor scores are determined with the processor 202 (FIG. 2) for each resting order based on the order book data [block 306]. As described above, the order quality factor scores include a first factor score indicative of order quantity or size, a second factor score indicative of order book position, and a third factor score indicative of order duration. To those ends, the determination may include determining a quantity rating [block 308] through bucketing or other processing, determining a book level position [block 310], and computing an order duration and determining a duration rating [block 312].

In the embodiment of FIG. 3, the factor scores may then be combined or aggregated by computing an initial order quality score for each resting order [block 314]. The initial order quality score may be a summation or other computation, as described above. In other embodiments, the computation is implemented later in the operation.

In the example of FIG. 3, the operation of the system 200 also includes determining, with the processor 202, a trader quality factor score for each resting order [block 316]. The trader quality factor score determination is based on the historical data for the trader associated with the respective order, as described above. For example, the previous rankings may be analyzed [block 318]. Alternatively or additionally, the quality scores of the past rankings may be analyzed. A decay factor may be computed for each resting order as the trader quality factor score [block 320], but other types of scores may be determined.

A ranking of the plurality of resting orders is then determined [block 322]. The determination is based on the order quality factor scores determined for each resting order. In some cases, the initial order quality score is determined at this point by aggregating the individual factor scores (if not determined already in connection with block 306). In either case, the initial order quality score may then be adjusted based on the trader quality factor score [block 324]. For example, the adjustment may include multiplying each initial order quantity score by a respective decay factor, as described above. The ranking of the orders may then be determined by sorting the orders in accordance with the adjusted scores [block 326].

The blocks described above may be implemented periodically in preparation of an allocation. Rankings may be updated and published weekly, monthly, or at other intervals. The rankings may then be used on a daily basis in between the updates to address incoming orders. In the embodiment of FIG. 3, an aggressor order is received [block 328]. The timing of the aggressor order may vary from the example shown. In an alternative embodiment, the ranking is determined on-the-fly upon receipt of the incoming order. Such on-demand rankings may be useful in relatively illiquid or inactive markets.

In any event, operation of the system 200 includes allocation of a volume of the aggressor order based on the rankings [block 330]. The allocation is made across a subset of the resting orders identified via the ranking. The allocation results in partial satisfaction of the incoming order. The allocation may be configured such that a greater percentage of the volume is allocated to higher ranked orders. In some cases, a threshold is applied to identify the resting orders to be allocated a percentage of the volume and thereby qualify traders for the quality-based allocation [block 332].

After the quality-based allocation, a remaining volume of the incoming order may be allocated in accordance with a further matching procedure [block 334]. The further matching procedure may vary as described above.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above may be a computer system 400 or a component in the computer system 400. The computer system 400 may implement a match engine on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate with a drive unit 406 and other components of the system 400 via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data.

The memory 404 is operable to store instructions 410 executable by the processor 402. The functions, acts or tasks illustrated in the figures or described herein may be performed by the programmed processor 402 executing the instructions 410 stored in the memory 404. The instructions 410 may be loaded or accessed from a computer-readable storage medium 412 in the drive unit 406 or other data storage device. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include an optical or other disk drive unit as the drive unit 406. The disk drive unit 406 may include the computer-readable storage medium 412 in which one or more sets of instructions 410, e.g. software, can be embedded. Further, the instructions 410 may embody one or more of the methods or logic as described herein. In a particular embodiment, the instructions 410 may reside completely, or at least partially, within the memory 404 and/or within the processor 402 during execution by the computer system 400. The memory 404 and the processor 402 also may include computer-readable storage media as discussed above.

The present disclosure contemplates a computer-readable medium that includes instructions 410 or receives and executes instructions 410 responsive to a propagated signal, which may be received via a communication interface 418. The system 400 may be connected to a network 420 to communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the terms “computer-readable medium” and “computer-readable storage medium” include a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable storage medium may be or include a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The disclosed computer programs (also known as a program, software, software application, script, or code) can be written in any form of programming language, including compiled or interpreted languages. The disclosed computer programs can be deployed in any form, including as a standalone program or as a module, component, subroutine, or other unit suitable for use in a computing environment. Such computer programs do not necessarily correspond to a file in a file system. Such programs can be stored in a portion of a file that holds other programs or data (e.g., one or more scripts stored in a markup language document), in a single file dedicated to the program in question, or in multiple coordinated files (e.g., files that store one or more modules, sub programs, or portions of code). Such computer programs can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor may receive instructions and data from a read only memory or a random access memory or both. The essential elements of a computer are a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer implemented method for matching an incoming order for a quantity of a financial product, the method comprising:
obtaining order book data indicative of a plurality of resting orders for the financial product that are unmatched and counter to the incoming order;
determining, with a processor, for each order of the plurality of resting orders, a set of order quality factor scores based on the order book data, the set of order quality factor scores including any combination of two or more of the following order quality factor scores: a first factor score indicative of order quantity; a second factor score indicative of order book position; and a third factor score indicative of order duration without modification;
determining a ranking of the plurality of resting orders based on the set of order quality factor scores determined for each order of the plurality of resting orders; and
allocating a volume of the incoming order across a subset of orders of the plurality of resting orders based on the ranking in partial satisfaction of the incoming order.

2. The computer implemented method of claim 1 further comprising:
obtaining historical data indicative of the rankings from one or more past ranking determinations; and
determining, with the processor, a trader quality factor score for each order of the plurality of resting orders based on the historical data for the trader associated with the respective order;
wherein determining the ranking comprises determining an order quality score for each order of the plurality of resting orders based on the trader quality factor score.

3. The computer implemented method of claim 2 wherein determining the ranking comprises:
computing an initial order quality score for each order of the plurality of resting orders based on the respective set of order quality factor scores; and
adjusting each initial order quality score based on the trader quality factor score.

4. The computer implemented method of claim 3 wherein:
determining the trader quality factor score comprises computing a decay factor for each order of the plurality of resting orders; and
adjusting each initial order quality score comprises multiplying each initial order quantity score by a respective decay factor.

5. The computer implemented method of claim 3 wherein computing the initial order quality score comprises summing the set of order quality factor scores.

6. The computer implemented method of claim 1 further comprising, after allocating the volume based on the ranking, allocating a remaining volume of the incoming order in accordance with a further matching procedure.

7. The computer implemented method of claim 6 wherein the further matching procedure is configured to implement a pro-rata algorithm, a first in first out (“FIFO”) algorithm, a Price Explicit Time algorithm, an Order Level Pro Rata algorithm, an Order Level Priority Pro Rata algorithm, a Preference Price Explicit Time algorithm, a Preference Order Level Pro Rata algorithm, a Preference Order Level Priority Pro Rata algorithm, a Threshold Pro-Rata algorithm, a Priority Threshold Pro-Rata algorithm, a Preference Threshold Pro-Rata algorithm, a Priority Preference Threshold Pro-Rata algorithm, a Split Price-Time Pro-Rata algorithm, or combinations thereof.

8. The computer implemented method of claim 1 wherein allocating the volume comprises distributing the volume across the subset of orders in a manner that allocates a greater percentage of the volume to higher ranked orders of the plurality of resting orders.

9. The computer implemented method of claim 1 wherein allocating the volume comprises applying a threshold to identify the orders of the plurality of resting orders to be allocated a percentage of the volume.

10. A system for matching an incoming order for a quantity of a financial product, the system comprising:
a processor;
a memory coupled with the processor;
first logic stored in the memory and executable by the processor to cause the processor to obtain order book data indicative of a plurality of resting orders for the financial product that are unmatched and counter to the incoming order;
second logic stored in the memory and executable by the processor to cause the processor to determine, for each order of the plurality of resting orders, a set of order quality factor scores based on the order book data, the set of order quality factor scores including any combination of two or more of the following order quality factor scores: a first factor score indicative of order quantity; a second factor score indicative of order book position; and a third factor score indicative of order duration without modification;
third logic stored in the memory and executable by the processor to cause the processor to determine a ranking of the plurality of resting orders based on the set of order quality factor scores determined for each order of the plurality of resting orders; and
fourth logic stored in the memory and executable by the processor to cause the processor to allocate a volume of the incoming order across a subset of orders of the plurality of resting orders based on the ranking in partial satisfaction of the incoming order.

11. The system of claim 10, further comprising fifth logic stored in the memory and executable by the processor to cause the processor to determine a trader quality factor score for each order of the plurality of resting orders based on historical data indicative of the ranking from one or more past ranking determinations for the trader associated with the respective order, wherein the third logic is further executable by the processor to cause the processor to determine an order quality score for each order of the plurality of resting orders based on the trader quality factor score.

12. The system of claim 11 wherein the third logic is further executable by the processor to cause the processor to compute an initial order quality score for each order of the plurality of resting orders based on the respective set of order quality factor scores, and to adjust each initial order quality score based on the trader quality factor score.

13. The system of claim 10 wherein the second logic is further executable by the processor to cause the processor to determine, for each order of the plurality of resting orders, an order quantity rating, a book level position rating, and an order duration rating, and to compute an initial order quality score for each order of the plurality of resting orders by the order quantity rating, the book level position rating, and the order duration rating.

14. The system of claim 10 wherein the fourth logic is further executable by the processor to cause the processor to distribute the volume across the subset of orders in a manner that allocates a greater percentage of the volume to higher ranked orders of the plurality of resting orders.

15. The system of claim 10 wherein the fourth logic is further executable by the processor to cause the processor to apply a threshold to identify the orders of the plurality of resting orders to be allocated a percentage of the volume.

16. A computer program product for matching an incoming order for a quantity of a financial product, the computer program product comprising one or more computer-readable storage media having stored thereon computer-executable instructions that, when executed by one or more processors of a computing system, cause the computing system to perform a method, the method comprising:
obtaining order book data indicative of a plurality of resting orders for the financial product that are unmatched and counter to the incoming order;
determining, with a processor, for each order of the plurality of resting orders, a set of order quality factor scores based on the order book data, the set of order quality factor scores including any combination of two or more of the following order quality factor scores: a first factor score indicative of order quantity; a second factor score indicative of order book position; and a third factor score indicative of order duration without modification;
determining a ranking of the plurality of resting orders based on the set of order quality factor scores determined for each order of the plurality of resting orders; and
allocating a volume of the incoming order across a subset of orders of the plurality of resting orders based on the ranking in partial satisfaction of the incoming order.

17. The computer program product of claim 16 wherein the method further comprises:
obtaining historical data indicative of the ranking from one or more past ranking determinations; and
determining, with the processor, a trader quality factor score for each order of the plurality of resting orders based on the historical data for the trader associated with the respective order;
wherein determining the ranking comprises determining an order quality score for each order of the plurality of resting orders based on the trader quality factor score.

18. The computer program product of claim 17 wherein determining the ranking comprises:
computing an initial order quality score for each order of the plurality of resting orders based on the respective set of order quality factor scores; and
adjusting each initial order quality score based on the trader quality factor score.

19. The computer program product of claim 18 wherein:
determining the trader quality factor score comprises computing a decay factor for each order of the plurality of resting orders; and
adjusting each initial order quality score comprises multiplying each initial order quantity score by a respective decay factor.

20. The computer program product of claim 16 wherein determining the set of order quality factor scores comprises:
determining, for each order of the plurality of resting orders, an order quantity rating, a book level position rating, and an order duration rating; and
computing an initial order quality score for each order of the plurality of resting orders by the order quantity rating, the book level position rating, and the order duration rating.
